(19) United States
(12) Patent Application Publication
(10) Pub. No.: US 2006/0168547 A1
(43) Pub. Date: Jul. 27, 2006

(54) METHOD AND SYSTEM FOR SYNCHRONIZING CONTENT IN MULTIPLE WEB BROWSER WINDOWS

(75) Inventors: Ryan A. Boyles, Raleigh, NC (US); Paul F. McMahan, Apex, NC (US); Richard B. Southard, Clayton, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/905,506

(22) Filed: Jan. 7, 2005

(51) Int. Cl. G06F 3/00; G06F 17/00

(52) U.S. Cl. 715/854

(57) ABSTRACT

A method for synchronizing content in multiple browser windows may include polling any child browser windows spawned from a parent browser window at predetermined time intervals to detect any changes in a respective child browser window. The method may also include updating or synchroinizing content in the parent browser window in response to detecting any changes in any child browser windows spawned from the parent browser window.

### BACKGROUND OF INVENTION

The present invention relates Internet or Web browsers and more particularly to a method and system for synchronizing content in multiple web browser windows.

Modern enterprise applications or the like use a web browser or Internet browser to render a user interface or browser window for accessing different Universal Resource Locators (URLs), web sites, domains or the like on a network, such as the Internet, private networks, intranets or the like. Certain interactions by a user in a browser window, which may be referred to as a parent browser window, may spawn other browser windows which may be referred to as child browser windows. For example, when a user clicks or operates a “help” icon in a web page, using a computer pointing device, mouse or the like, a new browser window is launched to display the contextual help. The user may also launch an action into a new browser window at any time by using a keyboard shortcut, context menu on a hyperlink or similar action or operation. As more browser windows are launched for display, means are needed to keep their collective content in synch and updated. If the content is not kept in synch, then some browser windows could display data that is no longer useful to the user, or, even worse, the data may become stale or invalid by some later interaction driven in another browser window.

Some web applications may extend a browser's default handler for hyperlink clicks using a JavaScript® method that synchronizes the content across browser windows and may optionally open a new browser window to show resulting content. One drawback to this technique is that it does not handle those cases where the browser window in which the user is interacting is closed or changes locations to a new domain. Under these circumstances, the JavaScript® in the active browser window can no longer interact with the other browser windows.

### SUMMARY OF INVENTION

In accordance with an embodiment of the present invention, a method for synchronizing content in multiple browser windows may include polling any child browser windows spawned from a parent browser window at predetermined time intervals to detect any changes. The method may also include updating or synchronizing content in the parent browser window in response to detecting any changes in any child browser windows spawned from the parent browser window.

In accordance with an embodiment of the present invention, a method for synchronizing content in multiple browser windows may include transmitting a polling message from a parent browser window to each child browser window spawned from the parent browser window. The method may also include designating any child browser window as being closed in response to not receiving a reply message responsive to the polling message after a predetermined time period. The method may further include processing a reply message from each child browser window that is open or active to determine any changes in each open child browser window. Additionally, the method may include updating or synchronizing content in any other open child browser windows spawned from the parent browser window in response to any reply message indicating a change in the child browser window that sent the reply message.

In accordance with another embodiment of the present invention, a system for synchronizing content in multiple browser windows may include a data structure operable on a processor to poll any child browser windows spawned from a parent browser window at predetermined time intervals to detect any changes. The system may also include a data structure operable on the processor to update or synchronize content in the parent browser window in response to detecting any changes in any child browser windows spawned from the parent browser window.

In accordance with another embodiment of the present invention, a computer program product for synchronizing content in multiple browser windows may include a computer readable medium having computer readable program code embodied therein. The computer readable program code may include computer readable program code configured to poll any child browser windows spawned from a parent browser window at predetermined time intervals to detect any changes. The computer readable program code may include computer readable program code configured to update or synchronize content in the parent browser window in response to detecting any changes in any child browser windows spawned from the parent browser window.

### DESCRIPTION OF THE DRAWINGS

FIG. 1 is a flow chart of an example of a method for synchronizing content in multiple browser windows in accordance with an embodiment of the present invention.

FIG. 2 is a flow chart of an example of a method for synchronizing content in multiple browser windows in accordance with another embodiment of the present invention.

FIG. 3 is an example of polling child browser windows spawned from a parent browser window to detect any changes in accordance with an embodiment of the present invention.

FIG. 4 is an example of updating other child browser windows spawned from a parent browser window in response to detecting changes in a child browser window in accordance with an embodiment of the present invention.

FIG. 5 is a block diagram of an exemplary system for synchronizing content in multiple browser windows in accordance with an embodiment of the present invention.

### DETAILED DESCRIPTION

The following detailed description of preferred embodiments refers to the accompanying drawings, which illustrate specific embodiments of the invention. Other embodiments having different structures and operations do not depart from the scope of the present invention.

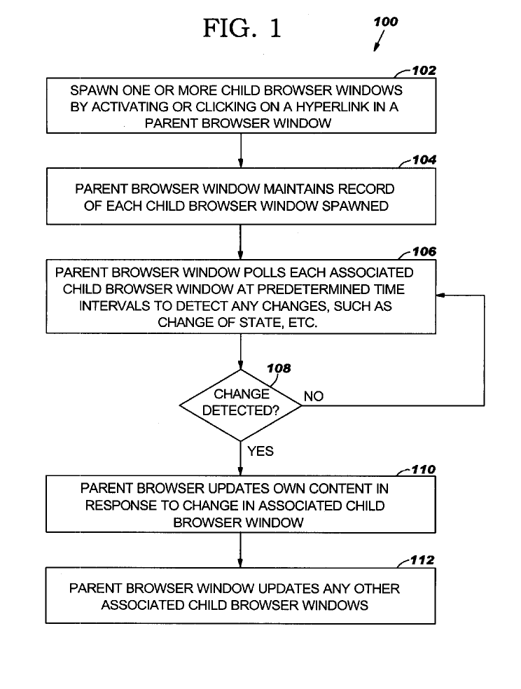

FIG. 1 is a flow chart of an example of a method 100 for synchronizing content in multiple browser windows in accordance with an embodiment of the present invention. In block 102, one or more child browser windows may be spawned from a parent browser window in response to a user clicking on or activating a hyperlink or performing some other action that may launch a new browser window or child window. In block 104, the parent or spawning browser window may maintain a record or track each child browser window spawned by the parent.

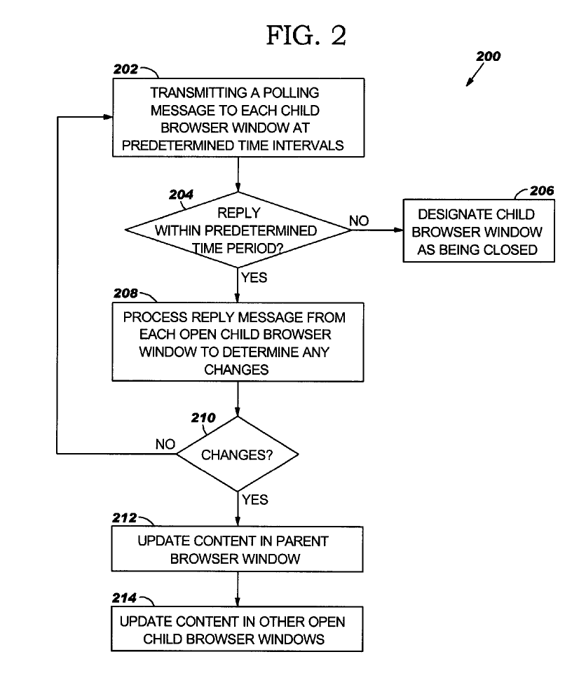

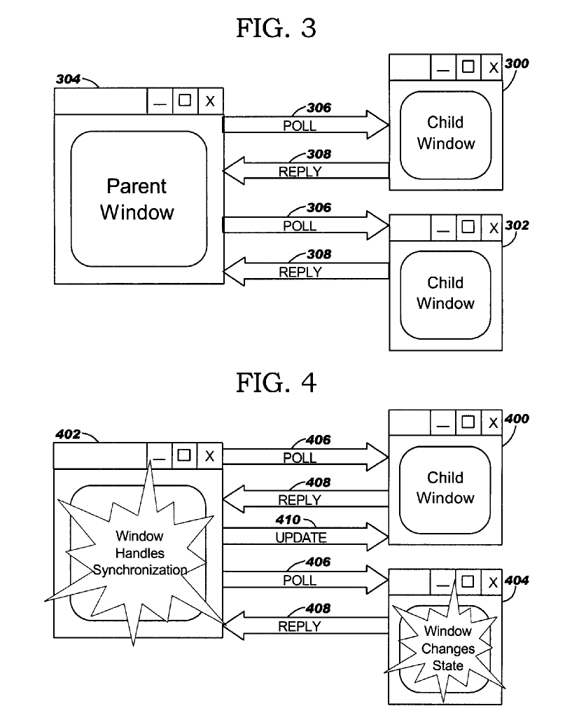

In block 106, the parent browser window may poll each associated child browser window spawned from the parent browser window to detect any changes. An example of a parent browser window polling each associated child browser window spawned by the parent browser window to detect any changes is described with respect to FIG. 3. The child browser windows spawned by the parent browser window may be polled at predetermined time intervals. In accordance with one embodiment of the present invention, as described in more detail with respect to FIG. 2, each child browser window may be polled by transmitting a polling message to each child browser window at predetermined time intervals.

In block 108, a determination may be made if a change has been detected in any child browser windows spawned from the parent browser window. Examples of changes in the child browser window may include, but are not limited to, closing the child browser window, changing locations or domains, updating content or similar changes in state. In one embodiment of the present invention, any changes may be detected by receiving or not receiving a reply message from each child browser window and processing any reply messages. If a reply message is not received within a predetermined time period, that child browser window may be designated as being closed or inactive in the record of spawned child browser windows. If a change in any child browser windows is not detected from the polling in block 108, the method 100 may return to block 106 and any child browser windows may be polled at the expiration of the next predetermined time interval.

If a change in any child browser window is detected in block 108, the method 100 may advance to block 110. In block 110, the parent browser may update its own content in response to any changes in any associated child browser or synchronize its content with the content of any associated child browser windows that changed. In block 112, the parent browser window may also update or synchronize the content of any other associated child browser windows spawned by the parent browser window in response to detecting any changes in one or more of the associated child browser windows.

FIG. 2 is a flow chart of an example of a method 200 for synchronizing content in multiple browser windows in accordance with another embodiment of the present invention. In block 202, a polling message or the like may be sent by a parent browser window to each child browser window spawned from the parent browser window. The polling message may be sent at predetermined time intervals to detect any changes in the associated child browser windows. An example of a parent browser window sending a polling message or the like to each child browser window spawned from the parent browser window will be described with reference to FIG. 3.

In block 204, a determination may be made if a reply message, signal or the like was received by the parent browser window within a predetermined time period. If a reply message was not received within the predetermined time period for reply in block 204, the method 200 may advance to block 206 and the child browser window that failed to reply or respond may be designated by the parent browser window as being closed or inactive.

If a reply message was received from each open or active child browser window within the predetermined time period in block 204, the reply message from each open child browser window may be processed in block 208. The reply message from each child browser window may be processed to determine if there are any changes in the respective child browser window that sent the reply message. In block 210, a determination may be made if there are any changes from processing the reply message from each open child browser window in block 208. If there are no changes in block 210, the method 200 may return to block 202 and the method 200 may continue as previously described. If there are changes to any child browser window spawned from the parent browser window in block 210, the method 200 may advance to block 212.

In block 212, the content in the parent browser window may be undated or synchronized to coordinate with any changes in any of the open or active child browser windows. In block 214, the content in other open child browser windows spawned from the parent browser window may also be updated or synchronized in response to any reply message indicating a change in a child browser window that sent the reply message. Accordingly, each open or active child browser window spawned from the same parent browser window may be updated or synchronized to coordinate with any changes to other child browser windows spawned by the same parent browser window as detected by polling each open or active child browser window in method 200. Each open or active child browser window may be updated or synchronized by transmitting an update content message from the parent browser window to any other open or active child browser windows in response to any reply message indicating a change in a child browser window that sent the reply message. The other child browser windows may then update or synchronize their content to coordinate with the changed or altered child browser window accordingly.

FIG. 3 is an example of polling child browser windows 300 and 302 spawned from a parent browser window 304 to detect any changes in accordance with an embodiment of the present invention. The parent browser window 304 may transmit a polling message 306 to each child browser window 300 and 302. Each open or active child browser window 300 and 302 may then respond by sending a reply message 308. The reply message 308 may indicate any changes in the child browser window 300 or 302 sending the reply message 308.

FIG. 4 is an example of updating another child browser window 400 spawned from a parent browser window 402 in response to detecting changes in a child browser window 404 in accordance with an embodiment of the present invention. Similar to that described with respect to FIG. 3, the parent browser window 402 may transmit a polling message 406 to each child browser window 400 and 404. Each open or active child browser window 400 and 404 may transmit a reply message 408. The reply message 408 may indicate any changes in the child browser window 400 or 404 that transmits the reply message 408. In the example shown in FIG. 4, child browser window 404 has experienced a change, such as a change in state. Accordingly, the reply message 408 may indicate the change and the nature of the change and any other information that may be needed to synchronize or update the content of the parent browser window 402 and other child browser windows, such as child browser window 400 in the example of FIG. 4. The reply messages 408 from child browser windows 400 and 404 may be processed by the parent browser window 402 to detect or determine any changes in the child browser windows 400 and 404 and what updates or synchronization needs to occur. An update message 410 may be generated and transmitted to other child browser windows, such as child browser window 400, to update or synchronize the child browser window 400 in response to the changes in child browser window 404.

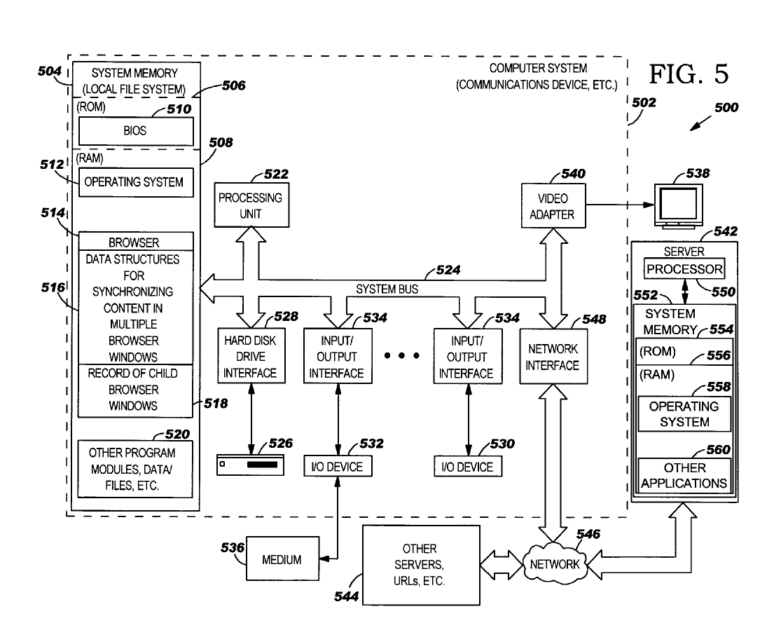

FIG. 5 is a block schematic diagram of an exemplary system 500 for synchronizing content in multiple browser windows in accordance with an embodiment of the present invention. The methods 100 and 200 may be embodied in and performed by the system 500. The system 500 may include a computer system 502 or similar system or device. The computer system 502 may also be a communications device, such as a cellular telephone, mobile computing system, personal digital assistant or similar device capable browsing or accessing the Internet, private network, intranet or the like.

The computer system 502 may include a system memory or local file system 504. The system memory 504 may include a read only memory (ROM) 506 and a random access memory (RAM) 508. The ROM 506 may include a basic input/output system (BIOS) 510. The BIOS 510 may contain basic routines that help to transfer information between elements or components of the computer system 502. The RAM 508 may contain an operating system 512 to control overall operation of the computer system 502. The RAM 508 may also include a browser 514 or web browser. The RAM 508 may also include data structures 516 or computer-executable code for synchronizing content in multiple browser windows in accordance with an embodiment of the present invention. The RAM 508 may also include memory allocation to maintain a record 518 of any child browser windows spawned from a parent browser window to track the child browser windows similar to that described with respect to method 100 of FIG. 1. The data structures 516 and record 518 may form part of the browser 514 or may be separate applications or program modules. The RAM 508 may further include other application programs 520, other program modules, data, files and the like.

Elements of the present invention described with respect to method 100 of FIG. 1 and method 200 of FIG. 2 may be embodied in the system 500 and in the browser 514 and data structures 516 for synchronizing content in multiple browser windows. The data structures 516 may include computer readable or executable program code configured to poll any child browser windows spawned by a parent browser window to detect changes. The data structures 516 may include code configured to poll the child browser windows at predetermined time intervals to detect any changes similar to that described with respect to methods 100 and 200 of FIGS. 1 and 2, respectively, and as illustrated in FIGS. 3 and 4. The data structures 516 may also include computer readable program code configured to update or synchronize content in a parent browser window and child browser windows in response to detecting any changes in any child browser windows spawned by the parent browser window.

The computer system 502 may also include a processor or processing unit 522 to control operations of the other components of the computer system 502. The operating system 512, browser 514, data structures 516 and other program modules 520 may be operable on the processing unit 522. The processing unit 522 may be coupled to the memory system 504 and other components of the computer system 502 by a system bus 524.

The computer system 502 may also include a hard drive 526. The hard drive 526 may be coupled to the system bus 524 by a hard drive interface 528. The hard drive 526 may also form part of the local file system 504 or system memory. Programs, software and data may be transferred and exchanged between the system memory 504 and the hard drive 526 for operation of the computer system 502.

The computer system 502 may also include multiple input devices, output devices or combination input/output devices 530 and 532. Each input/output device 530 and 532 may be coupled to the system bus 524 by an input/output interface 534. The input and output devices or combination I/O devices 530 and 532 permit a user to operate and interface with the computer system 502 and to control operation of the browser 514 and data structures 516 for synchronizing content in multiple browser windows. The I/O devices 530 may include a keyboard and computer pointing device or the like to perform the operations discussed above. The keyboard and pointing device 530 permit a user to enter search terms or keywords in a search engine (not shown) and to initiate a web search.

The I/O devices 532 may include disk drives, optical, mechanical, magnetic, or infrared input/output devices, modems or the like. The I/O devices 532 may be used to access a medium 536. The medium 536 may contain, store, communicate or transport computer-readable or computer-executable instructions or other information for use by or in connection with a system, such as the computer system 502

The computer system 502 may also include or be connected to a display or monitor 538. The monitor 538 may be coupled to the system bus 524 by a video adapter 540. The monitor 538 may be used to permit the user to interface with the computer system 502. The monitor 538 may present the parent browser windows and child browser windows spawned by each of the parent browser windows, such as the parent and child browser windows illustrated in the examples of FIGS. 3 and 4.

The computer system 502 may communicate with a remote server 542 and may access other servers or URLs 544 via a network 546. The system bus 524 may be coupled to the network 546 by a network interface 548. The network interface 548 may be a modem, Ethernet card, router, gateway or the like for coupling to the network 546. The coupling may be a wired connection or wireless. The network 546 may be the Internet, private network, an intranet or the like.

The server 542 may include a processor 550 to control operation of the server 542. The server 542 may also include a system memory 552. The system memory 552 may include a read only memory (ROM) 554 and random access memory (RAM) 556. ROM 554 and RAM 556 may be similar to ROM 506 and RAM 508 of computer system 502. The RAM 556 may include an operating system 558 to control operation of other components of the server 542. The RAM 556 may also include other applications 560, program modules, files or the like.

Elements of the present invention, such as method 100 of FIG. 1, method 200 of FIG. 2 and system 500 of FIG. 5, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in the medium for use by or in connection with a system, such as system 500 of FIG. 5. Examples of such a medium may be illustrated in FIG. 5 as network 546 or medium 536 and I/O devices 532. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for synchronizing content in multiple browser windows, comprising:
polling any child browser windows spawned from a parent browser window at predetermined time intervals to detect any changes; and
updating or synchronizing content in the parent browser window in response to detecting any changes in any child browser windows spawned from the parent browser window.

2. The method of claim 1, further comprising updating or synchronizing content in any other child browser windows spawned from the parent browser window in response to detecting any changes.

3. The method of claim 1, further comprising maintaining a record of each child browser window spawned from the parent browser window.

4. The method of claim 1, further comprising detecting any changes in each child browser window spawned from the parent browser window.

5. The method of claim 1, further comprising transmitting a polling message from the parent browser window to each child browser window spawned from the parent browser window.

6. The method of claim 1, further comprising:
transmitting a polling message from the parent browser window to each child browser window spawned from the parent browser window;
designating any child browser window as being closed in response to not receiving a reply message responsive to the polling message after a predetermined time period;
processing the reply message from each child browser window that is open to determine any changes in each child browser window; and
transmitting an update content message from the parent browser window to any other open child browser windows spawned from the parent browser window in response to any reply message indicating a change in the child browser window that sent the reply message.

7. A method for synchronizing content in multiple browser windows, comprising:
transmitting a polling message from a parent browser window to each child browser window spawned from the parent browser window;
designating any child browser window as being closed in response to not receiving a reply message responsive to the polling message after a predetermined time period;
processing the reply message from each child browser window that is open to determine any changes in each child browser window; and
updating content in any other open child browser windows spawned from the parent browser window in response to any reply message indicating a change in the child browser window that sent the reply message.

8. The method of claim 7, further comprising updating a content in the parent browser window in response to any reply message indicating a change in the child browser window that sent the reply message.

9. The method of claim 7, further comprising maintaining a record of each child browser window spawned from the parent browser window.

10. A system for synchronizing content in multiple browser windows, comprising:
a data structure operable on a processor to poll any child browser windows spawned from a parent browser window at predetermined time intervals to detect any changes; and
a data structure operable on the processor to update or synchronize content in the parent browser window in response to detecting any changes in any child browser windows spawned from the parent browser window.

11. The system of claim 10, further comprising a data structure to update content in any other child browser windows spawned from the parent browser window in response to detecting any changes in any child browser window.

12. The system of claim 10, further comprising means to maintain a record of each child browser spawned from the parent browser.

13. The system of claim 10, further comprising a data structure to detect any changes in each child browser window spawned from the parent browser window.

14. The system of claim 10, further comprising:
a data structure to transmit a polling message from the parent browser window to each child browser window spawned from the parent browser window;
a data structure to designate any child browser window as being closed in response to not receiving a reply message to the polling message after a predetermined time period;
a data structure to process a reply message from each child browser window that is open to determine any changes in each child browser window; and
a data structure to update or synchronize content in any other open child browser windows spawned from the parent browser window in response to any reply message indicating a change in the child browser window that sent the reply message.

15. A computer program product for synchronizing content in multiple browser windows, the computer program product comprising:
a computer readable medium having computer readable program code embodied therein, the computer readable program code including:
computer readable program code configured to poll any child browser windows spawned from a parent browser window at predetermined time intervals to detect any changes; and
computer readable program code configured to update or synchronize content in the parent browser window in response to detecting any changes in any child browser windows spawned from the parent browser window.

16. The computer program product of claim 15, further comprising computer readable program code configured to update or synchronize content in any other child browser windows spawned from the parent browser window in response to detecting any changes.

17. The computer program product of claim 15, further comprising computer readable program code configured to maintain a record of each child browser window spawned from the parent browser window.

18. The computer program product of claim 15, further comprising computer readable program code configured to detect any changes in each child browser window spawned from the parent browser window.

19. The computer program product of claim 15, further comprising computer readable program code configured to transmit a polling message from the parent browser window to each child browser window spawned from the parent browser window.

20. The computer program product of claim 15, further comprising:
computer readable program code configured to transmit a polling message from the parent browser window to each child browser window spawned from the parent browser window;
computer readable program code configured to designate any child browser window as being closed in response to not receiving a reply message responsive to the polling message after a predetermined time period;
computer readable program code configured to process the reply message from each child browser window that is open to determine any changes in each child browser window; and
computer readable program code configured to update or synchronize content in any other child browser windows spawned from the parent browser window in response to any reply message indicating a change in the child browser window that sent the reply message.
